(19) United States
(12) Patent Application Publication
(10) Pub. No.: US 2022/0336883 A1
(43) Pub. Date: Oct. 20, 2022

(54) REFRIGERANT-BASED BATTERY COOLING PLATE

(71) Applicant: Dana Canada Corporation, Oakville (CA)

(72) Inventors: Elmer GALVIS, Milton (CA); John G. BURGERS, Oakville (CA)

(21) Appl. No.: 17/233,275

(22) Filed: Apr. 16, 2021

(51) Int. Cl. H01M 10/6554; H01M 10/613; H01M 10/625; H01M 10/6556; H01M 10/6568

(52) U.S. Cl. CPC H01M 10/6554; H01M 10/613; H01M 10/625; H01M 10/6556; H01M 10/6568

(57) ABSTRACT

Methods and systems are provided for a refrigerant-based battery cooling plate. In one example, the cooling plate may be configured with a plurality of fluid channels configured with non-uniform diameters. The cooling plate may further include a plurality of mixing conduits extending between fluid channels.

### TECHNICAL FIELD

The present description relates generally to methods and systems for a battery cooling plate.

### BACKGROUND AND SUMMARY

Rechargeable batteries, such as, for example, batteries formed of lithium ion cells, can be used in electric vehicles/hybrid electric vehicles to power vehicle propulsion, operation, and auxiliary components. These batteries can be recharged by regenerative braking operations or an external power source. Battery performance and life may depend on the applied load (and therefore on the charge/discharge rate), as well as operating conditions (such as temperature). Batteries generally work efficiently over a range of discharge rates (e.g., C/8-2C), within a target range of operating temperatures (typically from 20° C. to 45° C.), and at relatively uniform temperature (e.g., temperature uniformity of less than 5° C.).

Batteries implemented in electric vehicles may demand dissipation of heat generated during battery operation for the battery to maintain optimal performance. The heat may be transferred to a working fluid that circulates through a cold plate coupled to the battery. The cold plate may be adjacent to the battery, have two plates sandwiching the battery, or have multiple plates arranged amongst battery cells. The cold plate may be configured with a fluid passage, e.g., channel, which may be configured with a plurality of channels for the working fluid, which absorbs heat generated by battery cells as the working fluid flows through the cold plate. The cold plate may thereby maintain the battery cells at the target operating temperature and maintain uniform temperature distribution.

The working fluid may be a refrigerant and may undergo a phase transition from a liquid to a gas as it circulates through the cold plate and extracts heat from the battery. In some examples, the phase transition begins before the refrigerant is delivered to the cold plate. For example, the refrigerant may be 70% liquid and 30% vapor upon entering the cold plate. During instances where the refrigerant enters the cold plate as a sub-cooled liquid, heat from the battery may raise the refrigerant temperature to at least the refrigerant boiling point. Refrigerant vapor quality, or percentage of refrigerant that is vapor, may therefore increase as the fluid flows through the cold plate. In some instances, the refrigerant may be heated beyond its boiling point, and a measure of the increase in temperature beyond the boiling point is referred to as superheat. By utilizing refrigerant as the working fluid, superheat may be achieved before the refrigerant exits the cold plate, thereby fully leveraging all available latent heat of the phase transition to maximize the cooling capacity of the refrigerant.

The refrigerant may be cycled through another heat exchange circuit of the vehicle. For example, the refrigerant may also be the working fluid in a heating, ventilation, and air conditioning (HVAC) system. As such, the refrigerant may be mixed with oil to lubricate a compressor of the HVAC system, where the miscible oil may be suspended as droplets in the refrigerant. Due to a higher boiling point of the oil relative to the refrigerant, vaporization of the oil does not occur in the cold plate of the battery. For example, as the mixture flows through the cold plate, drawing heat from the battery cells, refrigerant that is soluble in the oil may boil off as the oil temperature rises. The mixture may be sufficiently heated to drive vaporization of the refrigerant, but not the oil, by the time the mixture reaches a final portion of the fluid passage prior to exiting the cold plate.

The inventors herein have recognized challenges with cold plate configuration when paired with the refrigerant/oil mixture as the working fluid. As the mixture absorbs heat, flow of the mixture may become sluggish due to an increase in viscosity as the refrigerant vaporizes. As a result, oil may build up in a final portion of the fluid passage, and the oil may be unable to exit the cold plate due to loss of flow velocity as well as high surface tension and viscosity. Furthermore, even in circuits that include oil recovery systems to assist in reducing oil accumulation in the cold or an evaporator of the HVAC system, unbalanced superheat may still occur, resulting in uneven temperature distribution across the cold plate.

Attempts to address sufficient flow velocity in the plurality of cold plate fluid channels include modifying a geometry of the plurality of fluid channels. One example approach is shown by Abels et al. in U.S. 2012/0237805. Therein, the plurality of channels of a battery cell cooler are provided with a P-shaped narrowing of an outermost channel near a coolant exit, which may assist in accelerating coolant flow therethrough to push trapped air bubbles out of the cooler. A second example approach is shown by Haselden in U.S. Pat. No. 6,032,470. Therein, a channel of a pressed plate may be configured to reduce resistance to refrigerant flow. For example, a cross-sectional area of the channel may decrease progressively from an inlet to an outlet of the channel.

However, the inventors herein have recognized issues with the examples described above. For example, the P-shaped narrowing of Abels et al. presents an abrupt change in channel diameter located too close to the exit to provide a desired superheat control and oil return. In the example of Haselden, the progressive channel narrowing may be too gradual to effect sufficient flow acceleration for a refrigerant/oil mixture. Furthermore, both examples may result in uneven heat distribution across the plate.

In one example, the issues described above may be addressed by a cold plate for a battery, comprising a plurality of channels spaced apart from one another and arranged parallel, each channel of the plurality of channels including a narrowed portion, e.g., a portion with a reduced cross-section and diameter, extending between a common outlet of the plurality channels and an intermediate-point of each channel. In this way, superheat may be balanced among channels of the cold plate. In addition, oil suspended in vaporized refrigerant may be entrained out of the cold plate. Furthermore, bends in the narrowed portions act to deposit entrained oil onto the channel walls where refrigerant soluble in oil can be liberated by heat absorbed directly from the channel wall.

As one example, the intermediate-point where narrowing of the channel diameters occurs may be a point where a vapor quality of the refrigerant within the refrigerant mix reaches a threshold. By reducing channel diameter when the vapor quality reaches the threshold, a proportion of vapor to liquid may be optimized to maintain suspension of the oil droplets while promoting removal of the oil from the cold plate via increased flow velocity. Additionally, mixing channels may be arranged along the portion of the flow channels with reduced channel diameter to enable mixing between channels. Oil buildup in final sections of the cold plate channels may be minimized by balancing superheat across the cold plate and driving fast flow velocities therethrough. As a result, cold plate efficiency may be increased to provide effective thermal management of the battery of an electric or hybrid electric vehicle.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example of an electrified vehicle drive train including a battery cooled by a cold plate.

FIG. 2 shows an example of a refrigerant circuit in a vehicle to which a battery cooling circuit may be coupled.

FIG. 3 shows a first example of a cold plate for a battery.

FIG. 4 shows the cold plate of FIG. 3, indicating regions configured to provide flow restriction.

FIG. 5 shows a second example of a cold plate for a battery configured with mixing conduits.

FIG. 6 shows an example flow of a refrigerant mix through a cold plate.

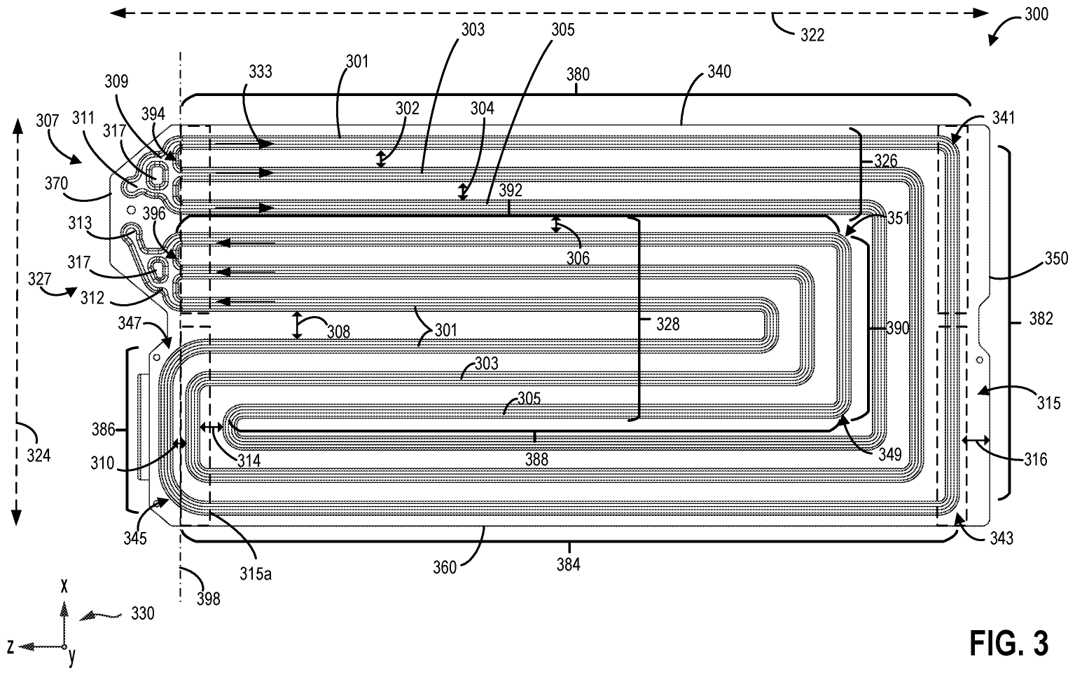

FIGS. 3-5 are shown approximately to scale.

### DETAILED DESCRIPTION

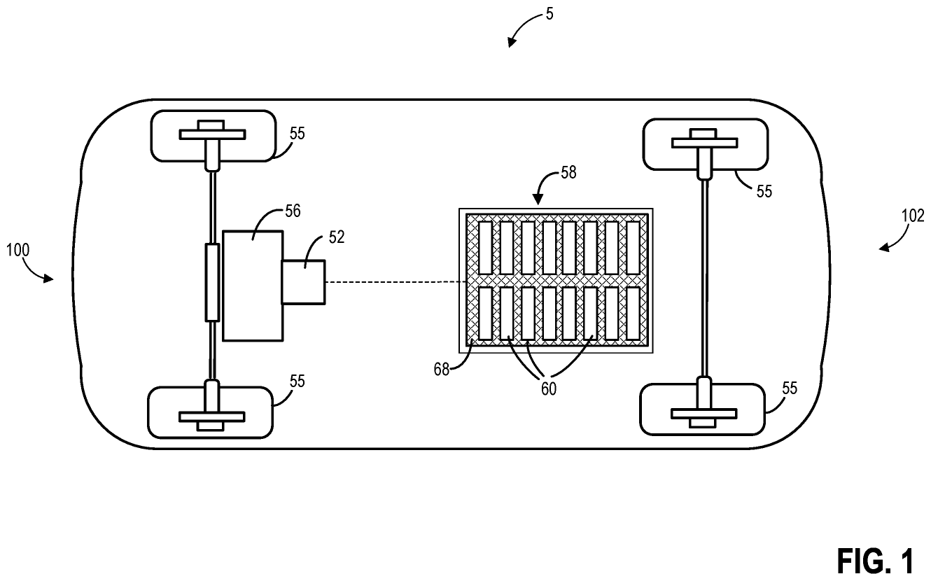

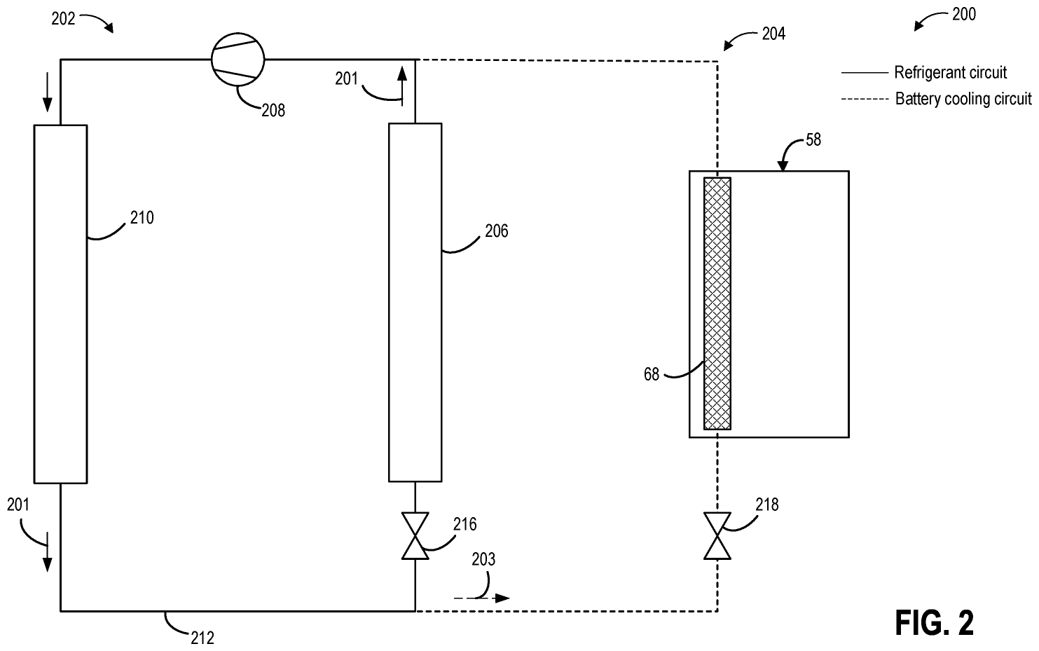

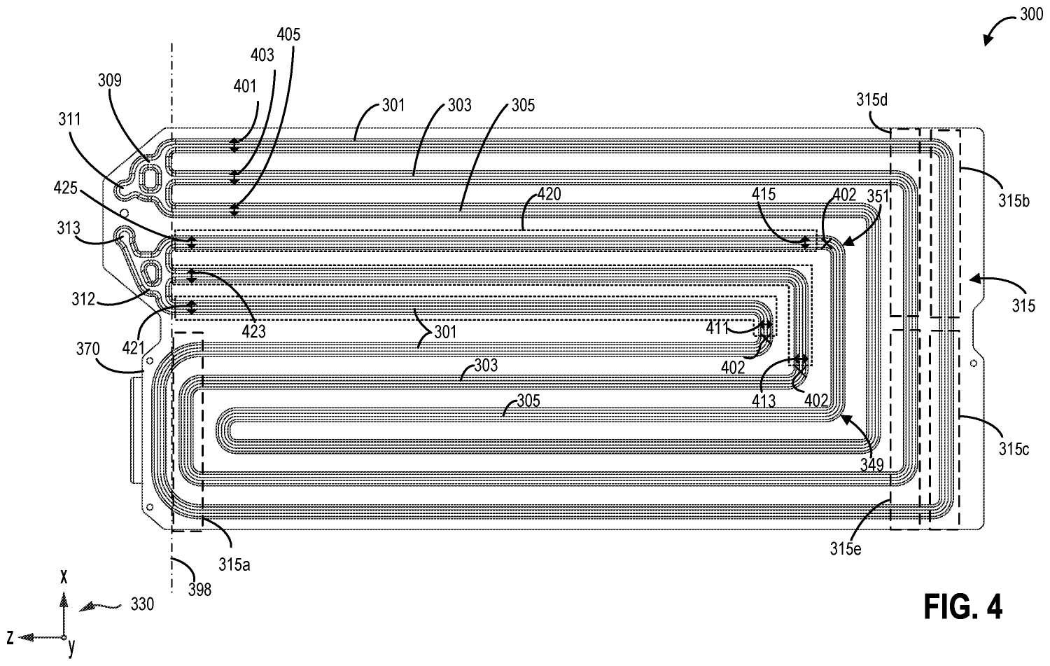

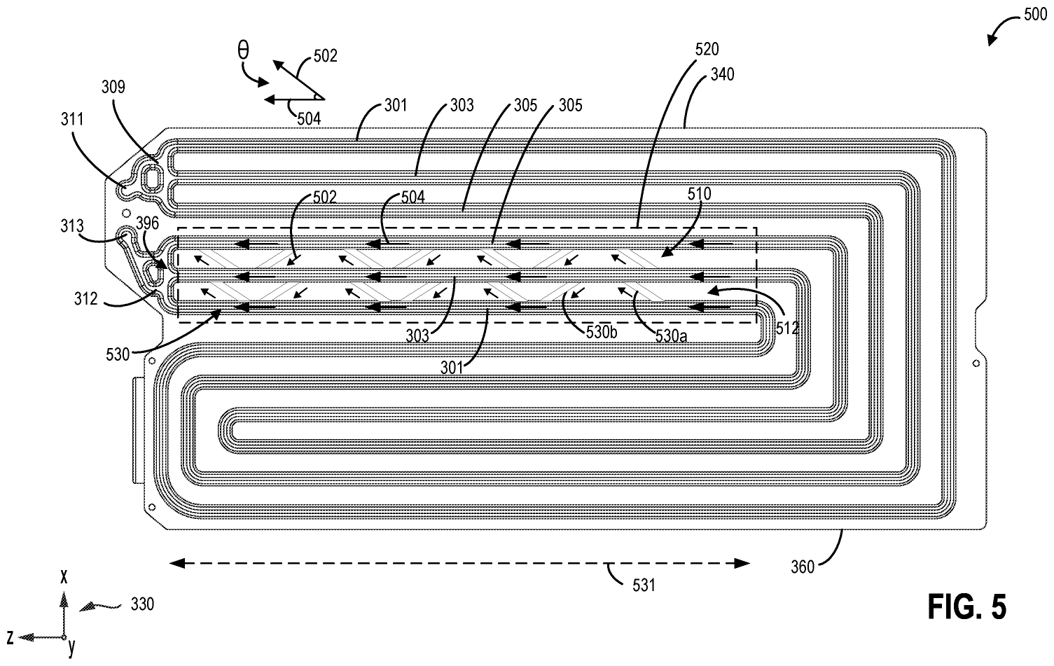

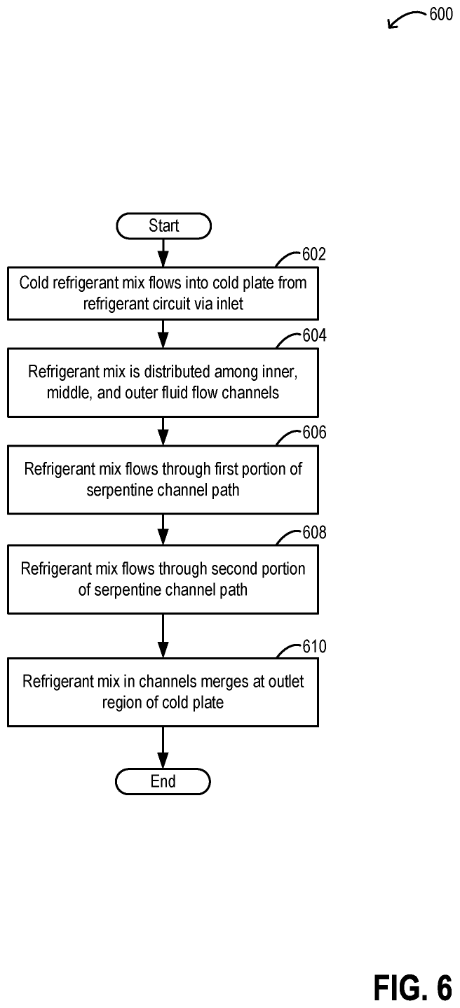

The following description relates to systems and methods for a refrigerant-based battery cooling plate. An example of a vehicle configured with an electrified vehicle drive train system, including a battery cooled by a cold plate, is shown in FIG. 1. FIG. 2 shows an example of a refrigerant circuit of the vehicle to which a battery cooling circuit may be coupled. A first example of a cold plate for cooling a battery is shown in FIG. 3. The cold plate may be configured to increase a cooling capacity resulting from a geometry of the cold plate, as described further below. The cold plate may include more than one channel for flowing a working fluid, such as a refrigerant, therethrough. The channels may include regions imposing a restriction on the refrigerant flow through the cold plate. Details of the cold plate are depicted in FIGS. 3 and 4. FIG. 5 shows a second example of a cold plate for cooling a battery configured with mixing conduits. An example flow of a refrigerant mix through a cold plate is depicted in FIG. 6.

FIGS.1-5 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Turning now to FIG. 1, an example vehicle 5 is shown with several interior components. In one example, vehicle 5 may be a hybrid electric vehicle (HEV) with multiple sources of torque available to one or more vehicle wheels 55, e.g., torque may be provided mechanically by an engine or electrically from an energy storage device such as a battery 58. As such, the battery 58 may be a traction battery 58. In other examples, vehicle 5 may be an all-electric vehicle (EV), powered exclusively by the battery 58. Vehicle 5 further includes an electric machine 52 which may be a motor or a motor/generator, for example. Electric machine 52 receives electrical power from the battery 58 which is converted to rotational energy, e.g., torque, which may be multiplied or reduced at a transmission 56. The torque is delivered to two or more of the vehicle wheels 55. Electric machine 52 may also be operated as a generator to provide electrical power to charge battery 58, e.g., during a braking operation.

While electric machine 52 is shown providing rotational energy to the vehicle wheels 55 proximate to a front end 100 of vehicle 5, e.g., front wheels of the vehicle, via the transmission 56, it will be appreciated that the transmission 56 may be alternatively arranged at rear wheels of vehicle 5, e.g., vehicle wheels 55 proximate to a rear end 102 of vehicle 5. When coupled to the rear wheels, energy from the electric machine 52 may be transmitted thereto. Furthermore, in other examples, each of the front wheels and the rear wheels may be coupled to individual transmission, such as when vehicle 5 is configured with all-wheel drive.

In the depicted example, the battery 58 may be installed in a rear region of the vehicle, e.g., proximate to the rear end 102 of the vehicle 5. In one example, the battery 58 may be positioned below rear passenger seats of the vehicle. In other examples, the battery 58 may be located in a floor of a rear compartment of the vehicle or may be integrated into a vehicle chassis, forming a floor of vehicle 5. The battery 58 may include a plurality of cells 60, the plurality of cells 60 electrically coupled to one another. A quantity of the plurality of cells 60 may determine a capacity of the battery 58. The battery 58 may be configured with a high power-to-weight ratio, high specific energy, and high energy density to provide power over long periods of time. Examples of battery types which may be used in vehicle 5 include lithium-ion, lithium polymer, lead-acid, nickel-cadmium, and nick-metal hydride batteries, amongst others.

Battery performance and longevity may be affected by temperature, and a range of optimal operating temperatures for battery operation may be narrow. During battery charge/discharge, internal resistances of battery components may drive an increase in battery temperature. In addition, chemical reactions occurring within each of the plurality of cells 60 may be exothermic. For example, a charging operation in nickel-metal hydride batteries may release large quantities of heat, leading to an increased likelihood of thermal runaway. As another example, charging of a lithium ion battery between 10-30° C. may prolong battery life while charging of the battery above 45° C. may lead to swelling of internal components, degradation of plastic components, loss of active chemicals to irreversible reactions, etc. In other battery types, battery discharge may instead lead to excessive heat generation which may rise as a rate of discharge increases. Furthermore, a demand for robust thermal management may be exacerbated in EV applications, where a traction battery for an EV may be larger than a traction battery for an HEV.

Heat extraction from the battery 58 may be enabled by implementation of a cold plate 68, as shown in FIG. 1, which may help maintain the battery temperature within the range of optimal operating temperatures, for example. In other examples, the cold plate 68 may be incorporated in a battery module or a battery pack to provide cooling to other regions of a battery assembly (where the battery assembly includes the battery 58). The cold plate 68 may conduct heat from the battery 58 via direct contact between the cold plate 68 and bottom faces of each of the plurality of cells 60 of the battery 58. In one example, the cold plate 68 may be a liquid channel cooling plate configured with a fluid passage configured with a plurality of channels to flow a heat exchange fluid therethrough, thereby providing cooling of the battery 58. As the heat exchange fluid flows through the plurality of channels, heat is transferred to the heat exchange fluid and removed from the cold plate as the heat exchange fluid is cycled between the cold plate and at least one heat exchanger.

As one example, as shown in FIG. 2, the battery 58 may be cooled via a direct cooling system 200 where a refrigerant is circulated therethrough. The direct cooling system 200 may include an air conditioning (AC) circuit 202 of a vehicle (e.g., vehicle 5 of FIG. 1), depicted in solid lines, and a battery cooling circuit 204, depicted in dashed lines. The AC circuit 202 may be used in a heating, ventilation, and air conditioning (HVAC) system of the vehicle to provide cabin heating and cooling, and includes an evaporator 206, a compressor 208, and a condenser 210, which may be fluidly coupled by refrigerant passages 212. Heat exchange from the air to the evaporator 206 assists in vaporizing the refrigerant.

The vaporized refrigerant flows, as indicated by arrows 201, to the compressor 208, which pressurizes the vapor. The pressurized vapor is delivered to the condenser 210 where heat may be transferred from the vaporized refrigerant to air or a vehicle coolant, thereby enabling the refrigerant to condense while flowing through the condenser 210. A first portion of the refrigerant exiting the condenser 210 may flow through a first expansion device 216 before returning to the evaporator 206. A second portion of the refrigerant exiting the condenser 210 may be directed to the battery cooling circuit 204, as indicated by arrow 203, which may include a second expansion device 218 and the cold plate 68 of the battery 58. The first and second expansion devices 216, 218 may rapidly reduce a pressure of the refrigerant before the refrigerant circulates through the evaporator 206 and the cold plate 68, respectively. As such, a temperature of the refrigerant is reduced prior to entering the evaporator 206 and the cold plate 68.

As the refrigerant flows through the fluid passage of the cold plate 68, absorption of heat from the battery 58 may heat the refrigerant to at least its boiling point. As a result, the refrigerant may leave the cold plate 68 at least partially vaporized. By selecting a refrigerant with a boiling point at or below an expected temperature of the battery 58, when the battery 58 is charging/discharging, a convective boiling of the refrigerant is increased relative to non-boiling fluids. The heated and vaporized refrigerant returns to the AC circuit 202 to combine with the first portion of the refrigerant leaving the evaporator 206 and undergo compression at the compressor 208.

Various types of refrigerant may be used, such as 1,1,1,2-tetrafluoroethane (R-134a), 2,3,3,3-tetrafluoropropene (R1234yf), carbon dioxide, and organic fluids such as, but not limited to, butane, methane, and propane. The refrigerant may be selected based on properties such as noncorrosive interactions with battery parts, a boiling point within a target temperature range, a high heat of vaporization, a desired viscosity, a desired density, etc. In some examples, the refrigerant may be mixed with oil to lubricate the compressor, e.g., the compressor 208 of FIG. 2, in the refrigerant circuit of the vehicle. A mass fraction of the oil in the mixture may be, in one example, between 0.5% to 1%. In other examples, the mass fraction of the oil may be between 3-5% in order to provide sufficient oil return to the compressor. The oil may be a natural oil such as, for example, mineral oil, or a synthetic oil, such as polyolester or polyalkylglycol, and may be suspended as droplets in the vaporized refrigerant, or may form an emulsion with liquid, liquid-vapor mixtures, or vaporized refrigerant.

Due to a higher boiling point of the oil relative to the refrigerant, vaporization of the oil does not occur in the cold plate of the battery. For example, as the mixture flows through the cold plate, drawing heat from the battery cells, the mixture may be sufficiently heated to drive vaporization of the refrigerant by the time the mixture reaches a final portion of the fluid passage prior to exiting the cold plate. The refrigerant may vaporize but the oil droplets may remain in the liquid phase and flow of the oil may become sluggish due to increased viscosity upon vaporization of the refrigerant.

In one example, the issues described above may be at least partially addressed by a cold plate adapted with fluid passages of non-uniform cross-sectional area, with at least a portion of at least one fluid passage shifted away from a source of heat to the cold plate, as well as mixing conduits disposed along at least a portion of the fluid passages. In this way, more uniform heat distribution between the fluid passages of the cold plate may be promoted, thereby balancing refrigerant super-heat between the fluid passages, where super-heat is the difference between the actual temperature and the boiling point/saturation temperature of refrigerant. Furthermore, a flow rate of vaporized refrigerant may be increased due to the non-uniform fluid passage diameters, thereby increasing a likelihood that oil droplets are entrained out of the cold plate.

FIGS. 3-4 show a top view of a first embodiment of a cold plate 300, which may be an example of the cold plate 68 of FIG. 1, adapted with three parallel channels of non-uniform cross-sectional area. A set of reference axes 330 is provided for comparison between views, indicating a y-axis, an x-axis, and a z-axis. In some examples, the y-axis may be parallel with a direction of gravity (e.g., a vertical direction), the x-axis parallel with a horizontal direction, with the z-axis perpendicular to both the y-axis and the x-axis. The cold plate 300 may include a flat plate and a formed plate or, alternatively, two formed plates, each plate formed of a metal, such as aluminum, copper, stainless steel, etc. The plates may be brazed together to form a unitary plate with channels disposed therein. The cold plate 300 may be arranged in a battery, such as the battery 58 of FIGS. 1 and 2, (or in a battery module or a battery pack) such that the flat plate is an upper face of the cold plate 300 and the form plate is a bottom face of the cold plate 300.

The battery cells 315 may be arranged in two rows along a length 322 of the cold plate 300. While only four of the battery cells 315 are depicted in FIG. 3 and only five of the battery cells 315 are depicted in FIG. 4 for clarity, it will be appreciated that the battery may include various quantities of battery cells arranged over the cold plate 300 in a variety of configurations. For example, the cold plate 300 may be entirely covered by the battery cells 315 or only a portion of the cold plate 300 may be covered by the battery cells 315. As such, battery cells 315 may communicate heat to the cold plate 300 through a thermal interface material arranged therebetween. The thermal interface material may a thin, compliant layer of a material with a suitable thermal conductivity that fills in any air gaps in between the battery cells 315 (or portion of a battery assembly demanding cooling) and the cold plate 300. FIGS. 3-4 show an arrangement of the fluid channels across the cold plate 300 with positioning of the fluid channels visible through battery cells arranged on top of the flat plate, where the battery cells 315 are indicated by dashed rectangles and both the battery cells 315 and the flat plate are depicted as transparent in this representation.

Turning to FIG. 3, the cold plate 300 has a substantially rectangular outer geometry with a length 322 parallel with the z-axis and a width 324 parallel with the x-axis. The length 322 may be greater than the width 324. The cold plate 300 includes three parallel fluid channels: a first, outer channel 301, a second, middle channel 303, and a third, inner channel 305. The channels are arranged to maximize surface area coverage of the cold plate 300. For example, the channels may cover at least 95% of a surface area of the cold plate 300. Due to a geometry of the channels, described further below, the channels may have different total lengths. The channels are spaced apart from one another and do not merge except at a common inlet 311 and a common outlet 313. Each of the channels includes a first segment 380, a second segment 382, a third segment 384, a fourth segment 386, a fifth segment 388, a sixth segment 390, and a seventh segment 392, which are sequentially arranged such that each channel is continuous and uninterrupted. Each segment of the channels is positioned perpendicular to adjacent segments, e.g., the first segment 380 is parallel with the z-axis, the second segment 382 is parallel with the x-axis, and the third segment 384 is parallel with the z-axis, etc. Further, each of the aforementioned segments may be coupled to adjacent segments by 90-degree bends in the channels.

A distance between each channel may be uniform along lengths of the channels. For example, the outer channel 301 is separated from the middle channel 303 by a first distance 302, the middle channel 303 is separated from the inner channel 305 by a second distance 304, and the first and third segments 380, 384 of the inner channel 305 are separated from the seventh and fifth segments 392, 388 of the inner channel 305, respectively, by a third distance 306. The first distance 302, the second distance 304, and the third distance 306 may be similar or may differ from one another. Furthermore, each of the distances may be relatively uniform along the lengths of the channels except along the fourth segment 386 of the channels where the distances may be increased, as described further below. A fourth distance 308 separates the fifth segment 388 of the outer channel 301 from the seventh segment 392 of the outer channel 301. In one example, the fourth distance 308 is greater than the first distance 302, the second distance 304, and the third distance 306.

The outer channel 301 is spaced away from edges of the cold plate 300 by a fifth distance 316. The edges of the cold plate 300 includes a first edge 340, a second edge 350, a third edge 360, and a fourth edge 370. The fifth distance 316 may vary around the cold plate 300 due to variations in geometries of the edges and arrangement of the outer channel 301. For example, the fifth distance 316 may be relatively uniform and similar along the first edge 340 and the third edge 360, but may vary along the second edge 350 and the fourth edge 370 of the cold plate 300.

As described above, the segments of each of the outer, middle, and inner channels 301, 303, 305 are continuous and arranged perpendicular to adjacent segments. Each consecutive 90-degree turn of the channels, herein also referred to as “bend”, directs the channels along a serpentine path where the length of each segment of the channels varies depending on whether the segment is parallel with the length 322 or the width 324 of the cold plate 300. Thus, the first, third, fifth, and seventh segments 380, 384, 388, and 392 are longer for each channel than the second, fourth and sixth segments 382, 386, and 390.

The serpentine path of the channels (e.g., the outer, middle, and inner channels 301, 303, 305) begins at an inlet region 307 and ends at an outlet region 327 of cold plate 300. The inlet region 307 includes the inlet 311 and an inlet chamber 309. The outlet region includes the outlet 313 and an outlet chamber 312. For example, the channels extend from inlet chamber 309 fluidly coupled to the inlet 311 along an outer region 326 of the plate 300, proximate to the first edge 340 of the plate 300. The first segment 380 of the channels may extend along a portion of the length 322 of the cold plate 300 that is greater than half of the length 322. The first segment 380 of the channels are coupled to the second segment 382 of the channels by a first bend 341. The second segment 382 of the channels continue along the outer region 326 proximate to the second edge 350 of the cold plate 300 and intersect with the third segment 384 of the channels at a second bend 343. The second segment 382 of the channels extend along a portion of the width 324 of the cold plate 300 that is greater than half of the width 324.

The third segment 384 of the channels extend along the outer region 326 of the plate 300 proximate to the third edge 360 and may be similar in length as the first segment 380. At a third bend 345, the third segment 384 of the channels connect with the fourth segment 386 of the channels. The fourth segment 386 of the channels extend along the outer region 326 of the cold plate 300 proximate to the fourth edge 370. However, a length of the fourth segment 386 is shorter than a length of the second segment 382 of the channels. For example, the fourth segment 386 may extend along a portion of the width 324 of the cold plate 300 that is less than half of the width 324.

At the fourth segment 386 of the channels, the outer channel 301 may be shifted outwards, e.g., towards the fourth edge 370 of the cold plate 300, thereby increasing the distances between the channels, as described above. For example, the outer channel 301 may be positioned such that the fourth segment 386 of the outer channel 301 is not aligned with inlet ends 394 and outlet ends 396 of the channels along the x-axis, as indicated by dashed line 398. A sixth distance 310 separates the fourth segment 386 of the outer channel 301 from the fourth segment 386 of the middle channel 303. In one example, the sixth distance 310 is less than the first distance 302, the second distance 304, the third distance 306, the fourth distance 308, and the fifth distance 316. A seventh distance 314 separates the fourth segment 386 of the middle channel 303 from the fourth segment 386 of the inner channel 305. In one example, the seventh distance 314 is greater than the first distance 302, the second distance 304, the third distance 306, and the sixth distance 310, and is less than the fourth distance 308 and the fifth distance 316. By shifting the outer channel 301 outwards, e.g., away from dashed line 398, the outer channel 301 is spaced away from an adjacent first battery cell 315a of the battery cells 315 that is closest to the fourth segment 386 of the outer channel 301. The outer channel 301 therefore does not contact any of the battery cells 315 at the fourth segment 386.

The fourth segment 386 of the channels intersect with the fifth segment 388 of the channels at a fourth bend 347. The channels wind back, e.g., folds back by a total of 180 degrees, such that the fifth segment 388 extends along, e.g., beside or adjacent to, the third segment 384 of the channels through an inner region 328 of the cold plate 300. As such, a first portion of the channels (e.g., in the outer region 326 of the cold plate 300) is concentric and co-planar with a second portion of the channels (e.g., in the inner region 328 of the cold plate 300) and the first portion at least partially surrounds the second portion of the channels. A length of the fifth segment 388 may be less than the length of first segment 380 as well as less than the length of the third segment 384 and may extend along a portion of the length 322 of the cold plate 300 that is greater than half of the length 322.

At a fifth bend 349, the fifth segment 388 of the channels intersects with the sixth segment 390 of the channels. The sixth segment 390 within the inner region 328 extends parallel with and adjacent to the second segment 382 of the channels of the cold plate 300. A length of the sixth segment 390 may extend along a portion of the width 324 of the cold plate 300 that is equal to half or less of the width 324 and may also be shorter than the length of the second segment 382 of the channels.

The sixth segment 390 connects with the seventh segment 392 of the channels at a final, sixth bend 351. The seventh segment 392 is situated between the first segment 380 and the fifth segment 388 of the channels, and extends through the inner region 328 of the cold plate 300. The fluid channels are coupled to and merge at outlet chamber 312 that is fluidly coupled to the outlet 313. The inlet 311 and the outlet 313 may be positioned in a similar region of the cold plate 300, e.g., near an intersection of the first edge 340 with the fourth edge 370 of the cold plate 300 such that no other components are positioned between the inlet 311 and the outlet 313. Furthermore, the inlet 311 and the outlet 313 may be aligned along the x-axis.

Refrigerant mixed with oil (hereafter referred to as a refrigerant mix) from a refrigerant circuit, such as the AC circuit 202 of FIG. 2, may enter the cold plate 300 at the inlet 311, and flow into the inlet chamber 309. From the inlet chamber 309, the refrigerant mix may be distributed into the channels at the inlet ends 394, as indicated by arrows 333. In the example of FIG. 3, both the inlet and outlet chambers 309, 312 include a flow-directing structure 317 that directs fluid flow through the chambers, e.g., fluid is forced to flow around the flow-directing structure.

For example, fluid entering the cold plate 300 through the inlet 311 may be diverted around the flow-directing structure 317 before reaching the inlet ends 394 of the channels. By forcing the flow around the flow-directing structure 317, a liquid portion of the refrigerant mix is divided equally amongst each channel at the inlet ends 394. At the outlet chamber 312, outgoing fluid from the outlet ends 396 of the channels is collected at the flow-directing structure 317 and directed to the outlet 313. The refrigerant mix flows from the channels to the outlet chamber 312 in the direction indicated by arrows 333 and exits the cold plate at the outlet 313 to return to the refrigerant circuit. The flow-directing structure 317 positioned in each of the inlet chamber 309 and the outlet chamber 312 may also provide structural support to the respective chambers by resisting an internal pressure of the cold plate 300 and supporting a weight of any adjoining battery or vehicle components.

As the refrigerant mix flows through the channels, the refrigerant mix absorbs heat conducted from the battery cells through the material of the cold plate 300, and the temperature of the refrigerant mix increases. The refrigerant of the refrigerant mix may be heated to at least its boiling point, thus increasing the vapor quality of the refrigerant, where vapor quality is the percentage of a saturated mixture that is vapor. As the refrigerant mix flows through the channels, the vapor quality may increase. For example, the vapor quality may be between 0-30% at the inlet 311 and reach between 85-100% at the outlet 313 of the cold plate 300. Due to a higher boiling point of oil in the refrigerant mix relative to the refrigerant, vaporization of the oil does not occur in the cold plate of the battery. Despite an escape of miscible refrigerant from the oil via vaporization, oil does not undergo a phase change within the channels of the cold plate and remains suspended as liquid mist within the vaporized refrigerant flow and/or as a flowing oil layer on the channel walls. Oil flow may become sluggish in comparison to vaporized refrigerant due to increased viscosity of the refrigerant mix as the refrigerant becomes increasingly vaporized. The oil may accumulate in the final portions of the channels, e.g., at least the sixth and seventh segments 390 and 392 of the channels of the cold plate 300, and form a larger mass fraction of the refrigerant mix therein. The collected oil forms a layer on the channel walls which may impede heat flow, thereby degrading a cooling capacity of the cold plate at the final portions of the channels.

Accumulation of oil in the final portions of the channels may be mitigated by increasing a flow rate of vaporized refrigerant therethrough. As such, entrainment of oil droplets out of the cold plate may be increased as well as shear promoting flow of the oil layer along the channel walls. This may be achieved by implementing non-uniform channel areas in the cold plate 300, as indicated in FIG. 4. By creating a region of restricted flow area in each of the channels, a pressure gradient may be accentuated that drives an increase in flow velocity, thereby driving faster flow out of the cold plate and reducing oil retention and deposition of oil droplets. Furthermore, the pressure gradient may depress a boiling point of the refrigerant, thereby increasing a super-heat of the refrigerant in the final portions of the channels.

Turning to FIG. 4, regions are indicated where a cross-sectional area of each of the outer channel 301, middle channel 303, and inner channel 305 may be narrowed. The diameters of the channels are herein also referred to as “widths” of the channels. In one example, a first diameter 401 of the outer channel 301 may be larger than a first diameter 403 of the middle channel 303, which may be larger than a first diameter 405 of the inner channel 305. However, in other examples, the channels may have similar diameters. The widths of each of the first diameter 401 of the outer channel 301, the first diameter 403 of the middle channel 303, and the first diameter 405 of the inner channel 305 may be relatively uniform until a threshold intermediate-point 402 along each of the channels. For example, the threshold intermediate-point 402 may be disposed at 70-80% of the lengths of the channels. In other words, a first portion of the channels may extend from the inlet chamber 309 to the threshold intermediate-point 402 which may represent, for example, 70-80% of the total length of each channel. However, in other examples, the threshold intermediate-point 402 may be at some other point along the lengths of the channels.

After the threshold intermediate-point 402 of the channels, the areas of the channels may be narrowed. For example, a second portion of the channels extending between the threshold intermediate-point 402 and the outlet chamber 312 is indicated by dashed regions 420. For the outer channel 301, the threshold intermediate-point 402 may be located at the fifth bend 349 of the outer channel 301. The threshold intermediate-point 402 of the middle channel 303 may also be located at the fifth bend 349. However, the threshold intermediate-point 402 of the inner channel 305 may instead be located at the sixth bend 351. A length of the second portion may thus vary between the channels. For example, the length of the second portion of the middle channel 303 may be longer than the lengths of the second portions of both the outer channel 301 and the inner channel 305, while the length of the second portion of the outer channel 301 may be longer than the length of the second portion of the inner channel 305. These regions may encompass approximately 20-30%, for example, of each total channel length. However, the portions of the channel length formed by these regions may vary in other examples.

The threshold intermediate-point 402 of the channels may represent a point along the lengths of the channels where the vapor quality reaches a threshold amount such as, for example, 85%. In one example, 85% vapor quality may be achieved at approximately the fifth bend 349 for the outer and middle channels 301, 303 and at the sixth bend 351 for the inner channel 305. The threshold amount may vary in other examples, however, and may represent a balance between achieving a uniform temperature distribution over a surface of the cold plate 300, as close to 100% vapor quality at the outlet 313 as possible, and purging of the oil from the cold plate 300. The configuration of the channels moderates increases in surface temperature of the cold plate 300 associated with high quality flows by intensifying a loss of pressure through the channels, resulting in a boiling point temperature depression of the refrigerant. As such, the position of threshold intermediate-point 402 may vary according to anticipated use-case conditions.

The second portion of the channels each have a second diameter 421, 423, and 425 that are reduced relative to the respective first diameters 411, 413, and 415, for the outer, middle, and inner channels. As an example, the second diameters of the channels may be reduced by up 13% and the cross-sectional areas reduced by 14% relative to the first diameters of the channels, for example. However, an amount of reduction in diameter and/or area may vary between 0-50%, in other examples. In one example, channel widths may be reduced by increasing the thickness of internal channel walls. In other examples, a height, defined along the y-axis, of the channels may be reduced to decrease a cross-sectional area of the channels, or both outer and inner diameters of the channels along the second portion may be similarly reduced, such that the thickness of the channel walls does not change.

The change in diameter, e.g., narrowing, of flow channels along the final portions of the channels increases the flow velocity of the refrigerant mix, which increases the likelihood that liquid mist and oil droplets suspended in vaporized refrigerant are entrained out of the cold plate 300. The lengths of the regions of narrowed channel diameter may be different amongst the channels depending on how far upstream a decrease in pressure effects uniform surface temperature of the cold plate 300 and complete boiling of the liquid refrigerant. A point where the narrowing of the channels begins may vary amongst the channels due to different threshold quality level demands corresponding to a configuration of each channel.

For example, the serpentine geometry of the channels may result in a greater portion of the outer channel 301 to be in direct contact with battery cells than the middle channel 303 or the inner channel 305. As shown in FIG. 4, only the outer channel 301 may be in direct contact with a second battery cell 315b and a third battery cell 315c of the battery cells 315. At a fourth battery cell 315d and a fifth battery cell 315e, the fourth and fifth battery cells 315d, 315e adjacent to the second and third battery cells 315b, 315c, respectively, only the outer channel 301 and the middle channel 303 may be in direct contact with the battery cells. All three channels may be in contact with all other battery cells 315. As such, the middle channel 303 and the outer channel 301 may absorb more heat overall then the inner channel 305. Furthermore, the exclusive heat exchange between the outer channel 301 and the second and third battery cells 315b, 315c may result in additional heat absorption at the outer channel 301 relative to the middle channel 303.

To at least partially offset extra heating of the outer channel 301, a portion of the outer channel 301 may be shifted to reduce contact between the outer channel 301 and the battery cells 315. For example, as described above, the fourth segment 386 of the outer channel 301 may be moved away from the first battery cell 315a along the z-axis in a direction towards the fourth edge 370 of the cold plate 300, as shown in FIGS. 3 and 4. Thus, the shifted portion of the outer channel 301 is not directly heated by the first battery cell 315a. Instead, heat from the first battery 315a is transferred to small sections of the outer channel 301 and to the fourth section 386 of the middle channel 303. This modification to the geometry of the outer channel 301 may enable more uniform distribution of heat from the battery cells amongst the refrigerant mix flowing through the channels.

Decreasing the diameters in the final portions of the channels creates a flow restriction, where a constant volume of fluid is forced to flow through a smaller cross-sectional area. The flow restriction generates a pronounced pressure gradient between the intermediate-point 402 and the outlet ends 396 of the channels, e.g., through the second portion 420 of the channels. For example, the pressure gradient within the second portion 420 may be greater than the pressure gradient of the first portion. The increased pressure gradient of the second portion 420 drives enhanced refrigerant vaporization, as the lower pressure in the second portion 420 may depress the refrigerant boiling point. The pressure gradient may also cause the flow velocity to increase through the second portion 420, accelerating the refrigerant mix through the second portion 420 of the flow channels to the outlet chamber 312 and outlet 313. This accelerated flow may maintain a relatively high velocity of liquid mist oil droplets suspended in vaporized refrigerant, thereby reducing deposition of oil in the second portion 420 of the channels. Thus, loss of cold plate cooling capacity may be mitigated.

However, given the different total lengths of the channels, the temperature of fluids exiting each of the channels may be non-uniform and super-heat values may differ between the channels at the outlet ends 396 of the channels. Balancing of super-heat and increased uniformity among the temperatures, vapor quality, and velocity of flow from each channel may be enabled by configuring the channels with mixing conduits along the second portion 420 of each channel, as shown in FIG. 5, allowing mixing of fluid amongst the channels.

FIG. 5 illustrates a second embodiment of a cold plate 500 with a plurality of mixing conduits 530 disposed along a region of the fluid channels, indicated by dashed region 520. A similar view of the cold plate 500 is depicted in FIG. 5 as the views of the cold plate 300 shown in FIGS. 3 and 4. Furthermore, the cold plate 500 has similar components as the cold plate 300 which are labelled as much as will not be re-introduced for brevity. Dashed region 520 is located within the second portion 420 of the channels, as shown in FIG. 4, at the seventh segment 392 of the channels where the channel diameters are decreased. A length 531 of dashed region 520 may be similar for each of the three channels. In one example, the length 531 may be similar to the length of the seventh segment 392 of the outer channel 301.

The mixing conduits 530 may be arranged to fluidly couple adjacent channels and act as bridging structures to allow mixing of fluid between adjacent channels. Flow through the mixing conduits 530 is indicated by arrows 502 and flow through the channels is indicated by arrows 504. The mixing conduits 530 are arranged in a first row 510, fluidly coupling the middle channel 303 to the inner channel 305, and a second row 512, fluidly coupling the outer channel 301 to the middle channel 303.

The mixing conduits 530 may extend diagonally, e.g., relative to the z-axis and relative to the direction of flow as indicated by arrows 504, between the channels. For example, a first conduit 530a of the mixing conduits 530 may extend from the outer channel 301 to the middle channel 303 at an angle θ relative to the z-axis. A second conduit 530b of the mixing conduits 530, the second conduit 530b downstream of the first conduit 530a, may extend from the outer channel 301 to the middle channel 303 at −θ relative to the z-axis. The mixing conduits 530 are thus arranged in an alternating pattern of + and −θ relative to the z-axis along the length 531 of dashed region 520. A diameter of the mixing conduits 530 may be smaller than the diameters of the channels and may be uniform along a length of the mixing conduits 530. In one example, θ may be 30 degrees relative to the z-axis and the mixing conduits 530 may alternate between orientations of +30 and −30 degrees relative to the direction of flow through the channels.

It will be appreciated that the mixing conduits 530 depicted in FIG. 5 are a non-limiting example of mixing conduits disposed between channels of the cold plate. Other examples may include variations in a geometry and positioning of the mixing conduits without departing from the scope of the present disclosure. For example, the mixing conduit diameters may not be uniform and may instead decrease along the length of the mixing conduits, e.g., the conduits may be tapered. While FIG. 5 shows an equal number of mixing conduits 530 in the first row 510 and the second row 512 of the mixing conduits 530, other examples may include different quantities of the mixing conduits between the rows as well as different quantities of the mixing conduits overall relative to the example of FIG. 5. Furthermore, in other examples, θ may vary anywhere between 30 to 60 (and −30 to −60) degrees.

By positioning the mixing conduits 530 in the second portion of the channels (e.g., the second portion 420 indicated in FIG. 4) where channel diameter is reduced to drive faster flow, a mixing effect of the mixing conduits 530 may be enhanced. Vaporized refrigerant within the second portion of the channels may flow quickly back and forth between adjacent channels via the mixing conduits 530. Rapid mixing in the dashed region 520 may allow equalization of temperature and pressure between the channels within the second portion and offset super-heat imbalance at the channel outlet ends 396.

A cold refrigerant mix, formed of refrigerant and oil, may thereby flow from a vehicle refrigerant circuit into a cold plate where the refrigerant mix is distributed amongst a plurality of flow channels arranged along a serpentine path. The plurality of flow channels may extend first along an outer region of the cold plate from a common inlet and bend to wind back along an inner region of the cold plate to merge at a common outlet. The refrigerant mix may flow through a first portion of the plurality of flow channels, absorbing heat from a plurality of battery cells coupled to the cold plate, driving an increase in refrigerant mix temperature. The refrigerant may be heated to at least the refrigerant boiling point, increasing a vapor quality of the refrigerant mix. The oil of the refrigerant mix may have a higher boiling point than the refrigerant, therefore oil vaporization does not occur in the cold plate and the oil may remain suspended as liquid mist within the increasingly vaporized refrigerant.

The diameters of the first portion of the plurality of flow channels may be greater than the diameters of the second portion of the plurality of flow channels. A flow restriction created by the reduction in channel diameter may generate a difference in pressure gradients between the two portions, where a pressure gradient of the first portion is less than a pressure gradient of the second portion. This increased pressure gradient in the second portion may drive increased vaporization of refrigerant in the second portion, and may increase the fluid flow rate of the refrigerant mix, increasing a likelihood that liquid oil droplets suspended in the vaporized refrigerant are flushed out of the cold plate.

The serpentine geometry of the plurality of flow channels may result in a greater portion of an outer channel of the plurality of flow channels to be in direct contact with the plurality of battery cells compared to a middle channel or an inner channel. To at least partially offset extra heating of the outer channel, a portion of the outer channel may be shifted away from a cell of the plurality of battery cells to reduce contact between the outer channel and the plurality of battery cells. This outer channel shift may enable more uniform distribution of heat from the plurality of battery cells across the plurality of flow channels.

The serpentine geometry of the flow channels may also result in variations in a total length between each of the plurality of flow channels. As a result, the temperature and super-heat of the refrigerant exiting each channel may be non-uniform. Balancing of super-heat and increased uniformity among the temperatures, vapor quality, and velocity of flow from each channel may be further enabled by configuring the plurality of flow channels with mixing conduits along the second portion, allowing mixing of fluid between the plurality of flow channels. Refrigerant may therefore exit the cold plate at a high, e.g., at or near 100%, vapor quality and at high velocity, carrying with it suspended liquid oil droplets. The increased vapor quality and velocity may reduce oil deposition in the second portion of the cold plate. Additionally, the inlet and outlet may be positioned in a similar region of the cold plate, which may at least partially mitigate development of a temperature gradient across the cold plate. Each of the cold plate adaptations, including a plurality of channels of non-uniform cross-sectional diameter, at least a portion of at least one fluid channel shifted away from a source of heat to the cold plate, and mixing conduits disposed along at least a portion of the fluid channels, may maintain or increase a cooling capacity of the cold plate by reducing the likelihood of oil buildup in the plurality of flow channels of the cold plate.

FIG. 6 depicts an example method 600 for flow of a refrigerant mix through a cold plate configured with a set of channels following a serpentine path, such as the cold plate 300 as described above with reference to FIGS. 3-5. The cold plate may be coupled to and in direct contact with a rechargeable battery, such as battery 58 depicted in FIG. 1. For example, the cold plate may be included in a battery assembly such that the cold plate is oriented in a horizontal positon with cells of the battery positioned on top of an upper surface of the cold plate. The cold plate may be fluidly coupled to the vehicle's AC circuit 202 which may circulate through an HVAC system as shown in FIG. 2. The refrigerant mix may be formed of a refrigerant mixed with an oil, as described above with reference to FIG. 2.

At 602, cold refrigerant mix flows into the cold plate from the refrigerant circuit of the HVAC system via an inlet. A temperature of the refrigerant may be low due to heat exchange at a condenser of the HVAC system and the refrigerant mix may be in a mostly fluid state with a low vapor quality. For example, the vapor quality may be between 0-30% at an inlet region of the cold plate, the inlet region including the inlet and an inlet chamber. From the inlet, the refrigerant mix flows through the inlet chamber, including flowing past a liquid and vapor-distributing structure, e.g., the flow-directing structure 317 of FIGS. 3-5, which directs and partitions the flow of liquid and vapor equally between the inlet ends of the set of channels.

At 604, the refrigerant mix is distributed among an inner channel, a middle channel, and an outer channel of the set of channels. In one example, the refrigerant mix may be equally divided among the channels. However, distribution of the liquid portion of the refrigerant mix flow may be commensurate with a total amount of heat absorbed, a working fluid flow rate, and a geometry, of each channel of the set of channels, thereby enabling superheat to be equalized between the set of channels at their outlet ends.

At 606, the refrigerant mix flows through a first portion of the serpentine channel paths through each of the inner, middle, and outer channels. The first portion of the serpentine channel paths commonly (e.g., common amongst all the channels) includes, for example, five segments which are sequentially arranged such that each channel is continuous and uninterrupted, and each segment is arranged perpendicular to adjacent segments. The first four segments of the five segments may extend along an outer region of the cold plate. As the refrigerant mix flows through the set of channels, the refrigerant mix absorbs heat from the battery cells via conduction, causing the temperature and vapor quality of the refrigerant mix to increase.

At the fourth segment of the set of channels, the outer channel is shifted away from a cell of the battery cells in closest proximity to the fourth segment of the outer channel and the segment is therefore not directly heated by the cell, as described above with reference to FIG. 3. Instead, heat from the cell is transferred to small sections of 90-degree bends coupling the third segment to the fourth segment and the fourth segment to the fifth segment of the outer channel, and also transferred to the fourth segment of the middle channel. By shifting the outer channel away from at least one of the battery cells, more uniform distribution of heat from the battery cells amongst the refrigerant mix flowing through the channels may be enabled. As the set of channels absorb heat, an amount of heat extracted may be different for each channel due to differing amounts of direct contact between each channel and the battery cells. Thus, for the middle channel and outer channel, the vapor quality may reach a threshold vapor quality at a sixth segment of the channels. For the inner channel, the vapor quality may reach the threshold vapor quality at a seventh segment of the channel. As such, a second portion of the set of channels where the vapor quality reaches the threshold vapor quality and narrowing of the channels begins may occur at a different point along each channel, depending on the geometry of the channel, as described above. The narrowing of the channels may be determined based on estimation of conditions to facilitate complete boiling of the refrigerant by the time the refrigerant exits the cold plate and to maintain a surface temperature of the cold plate below a target operating temperature of the battery cells, such as 5 degrees C. Furthermore, the start of the second portion may depend on geometric effects on retaining refrigerant mist within the cold plate while effectively returning oil to a compressor of the HVAC system.

At 608, the refrigerant mix enters and flows through a second portion of the serpentine channel path. The second portion begins at a point where vapor quality is expected to reach the threshold vapor quality for each channel. For the middle channel and outer channel, the second portions may include the sixth segment and the seventh segment. For the inner channel, the second portion may include the seventh segment. Within the second portion of the serpentine channel path, the cross-sectional diameters of the set of channels are reduced relative to the cross-sectional diameters of the set of channels in the first portion. The narrower diameters may create an increase in the pressure gradient within the second portion of the serpentine channel, relative to the first portion. The enhanced pressure gradient may increase flow velocity of the refrigerant mix, e.g., the flow may accelerate through the second portion. The refrigerant mix may continue to be heated as it flows through the second portion of the set of channels, driving further increase in vapor quality.

Additionally, a plurality of mixing conduits may be arranged within the second portion of the set of channels to facilitate mixing of the refrigerant mix between the flow channels. A first row of mixing conduits may be located between the inner channel and the middle channel and a second row of mixing conduits may be located between the middle channel and the outer channel. As the refrigerant mix flows through the second portion, at least a portion of the refrigerant mix in each channel may be diverted through the mixing conduits. For example, at least a portion of the flow through the inner channel may be directed through the first row of mixing conduits to the middle channel. At least a portion of the flow through the middle channel may be directed through each of the first row and the second row of mixing conduits to the inner and outer channels. At least a portion of the flow through the outer channel may be directed through the second row of mixing conduits to the middle channel. Within the second portion of the set of channels, the refrigerant mix flowing through each channel may mix with the refrigerant mix flowing through adjacent channels in the plurality of mixing conduits and proceed to flow into one or more of the channels after mixing. Intermixing of refrigerant flow may establish uniform flow velocity, super-heat, and vapor quality at a final section of each of the inner channel, middle channel, and outer channel, e.g., a final section of a total length of each channel upstream of a common outlet. At an outlet end of the set of channels, refrigerant vapor quality may reach a maximum vapor quality, such as 100%, where 100% of refrigerant is vaporized and oil is suspended as liquid mist within the refrigerant vapor.

At 610, the refrigerant mix in the inner channel, middle channel, and outer channel merge at an outlet region of the cold plate. The refrigerant mix in each channel no longer has distinct physical properties from the refrigerant mix in the other channels. For example, the refrigerant mix in each of the channels has a similar temperature, vapor quality, viscosity, etc. The outlet ends of the inner channel, middle channel, and outer channel are fluidly coupled to an outlet chamber, wherein refrigerant mix from each channel merges. Merging of refrigerant mix from the channels further homogenizes refrigerant mix vapor quality, super-heat, and flow velocity. A flow-directing structure located in the outlet chamber directs fluid flow through the outlet chamber to the outlet. A high flow velocity of the refrigerant mix, upon entering the outlet region and leaving the cold plate through the outlet, may increase a likelihood that oil droplets are entrained out of the cold plate. The refrigerant exits the cold plate as a vapor via the outlet, carrying with it suspended liquid mist oil droplets.

In this way, an efficiency and cooling capacity of a cold plate configured to cool a vehicle battery may be enhanced by reducing a likelihood of oil deposition within the cold plate channels. In one example, the cold plate is adapted with flow channels of non-uniform diameter, with at least a portion of at least one channel shifted away from a source of heat to the cold plate. The cold plate may also include mixing conduits disposed along at least a portion of the channels.

As a refrigerant mix, e.g., of refrigerant and oil, flows through the channels of the cold plate, the refrigerant mix absorbs heat from the battery cells and the refrigerant is at least partially vaporized. By reducing a diameter of the channels after a vapor quality of the refrigerant mix reaches a threshold, a pressure gradient is generated in the channels that causes the flow velocity to increase. Mixing conduits may be arranged along the portion of the flow channels with reduced channel diameter to balance temperature, vapor quality, and velocity between final sections of the channels. A portion of the outer channel may be shifted away from the battery cells to at least partially offset extra heating of the outer channel compared to the inner channel and middle channel. Refrigerant may therefore exit the cold plate at a high vapor quality and high velocity, carrying with it suspended liquid oil droplets. As such, a phase transition of the refrigerant may be leveraged to provide maximum cooling to the battery while alleviating oil deposition within the channels of the cold plate.

The technical effect of adapting a cold plate with fluid channels configured as described above, e.g., with non-uniform diameters, shifting of a section of at least one of the channels away from a heat source, and mixing conduits extending between the channels, is that flow through the channels may be increased near a common outlet to reduce oil deposition in the channels and provide more uniform heat distribution across the cold plate, thereby maintaining a battery within an optimized operational temperature range.

It will be appreciated that the configurations and routines disclosed herein are exemplary in nature, and that these specific embodiments are not to be considered in a limiting sense, because numerous variations are possible. For example, the above technology can be applied to various types of batteries, battery cells, and different arrangements of the batteries/battery cells relative to one or more cold plates. The subject matter of the present disclosure includes all novel and non-obvious combinations and sub-combinations of the various systems and configurations, and other features, functions, and/or properties disclosed herein.

The disclosure also provides support for a cold plate for a battery, comprising: a plurality of channels spaced apart from one another and arranged in parallel flow, each channel of the plurality of channels including a portion with one or more of a narrowed cross-sectional area, width, or diameter extending between a common outlet of the plurality of channels and an intermediate-point of each channel. In a first example of the system, a segment of an outer channel of the plurality of channels is shifted away from a battery cell to reduce heat transfer between the outer channel and the battery cell. In a second example of the system, optionally including the first example, the intermediate-point of each channel of the plurality of channels corresponds to a point along a total length of each channel where a vapor quality of a fluid flowing through the plurality of channels reaches a threshold and wherein a location of the intermediate-point along the total length differs amongst the plurality of channels. In a third example of the system, optionally including one or both of the first and second examples, the plurality of channels forms a serpentine path through the cold plate and wherein the plurality of channels extends along an outer region of the cold plate from a common inlet and bends to wind back along an inner region of the cold plate to merge at the common outlet. In a fourth example of the system, optionally including one or more or each of the first through third examples, the common inlet is arranged adjacent to the common outlet and wherein the common inlet and the common outlet are aligned along a width of the cold plate. In a fifth example of the system, optionally including one or more or each of the first through fourth examples, the portion of the outer channel shifted away from the battery cell extends along a same side of the cold plate as a common inlet and the common outlet. In a sixth example of the system, optionally including one or more or each of the first through fifth examples, the system further comprises: a plurality of mixing conduits fluidly coupling the plurality of channels to one another, the plurality of mixing conduits arranged within the portion with the one or more of the narrowed cross-sectional area, width, or diameter of each channel.

The disclosure also provides support for a battery cold plate, comprising: an inlet arranged adjacent to an outlet of the battery cold plate, the inlet and the outlet configured to flow a fluid into and out of the battery cold plate, respectively, one or more fluid channels extending between the inlet and the outlet, the one or more fluid channels each having first portion with a first diameter and a second portion with a second, reduced diameter, and wherein the second portion begins at a point along a length of each of the one or more fluid channels where a vapor quality of the fluid reaches a threshold and ends at the outlet. In a first example of the system, the inlet is arranged adjacent to the outlet without any components positioned between the inlet and the outlet. In a second example of the system, optionally including the first example, the one or more fluid channels includes a first, outer channel, a second, middle channel, and a third, inner channel and wherein the first, second, and third channels are arranged parallel with one another and spaced apart from one another between the inlet and the outlet. In a third example of the system, optionally including one or both of the first and second examples, each of the one or more fluid channels has a plurality of segments continuously coupled by 90-degree bends, and wherein at a fourth segment of the plurality of segments, the outer channel is shifted closer to an edge of the plate relative to an alignment of inlet and outlet ends of the one or more fluid channels along a width of the battery cold plate. In a fourth example of the system, optionally including one or more or each of the first through third examples, the system further comprises: a first row of mixing conduits extending between and fluidly coupling the first channel to the second channel and a second row of mixing conduits extending between and fluidly coupling the second channel to the third channel and wherein the first and second rows of mixing conduits are located along the second portion of the first, second and third channels. In a fifth example of the system, optionally including one or more or each of the first through fourth examples, the point where the vapor quality of the fluid reaches the threshold is positioned at a different location along a length of each of the one or more fluid channels. In a sixth example of the system, optionally including one or more or each of the first through fifth examples, the fluid is a mixture of a refrigerant and an oil and wherein the refrigerant has a lower boiling point than the oil. In a seventh example of the system, optionally including one or more or each of the first through sixth examples, the point where the vapor quality of the fluid reaches the threshold is a point where the vapor quality of the refrigerant reaches the threshold and the oil is at least partially suspended as a liquid mist in the refrigerant. In an eighth example of the system, optionally including one or more or each of the first through seventh examples, a pressure in the first portion is higher than a pressure in the second portion of the one or more fluid channels and a flow velocity is higher in the second portion than the first portion. In a ninth example of the system, optionally including one or more or each of the first through eighth examples, the threshold is a vapor quality configured to increase a pressure gradient in the second portion relative to the first portion of the one or more fluid channels. In a tenth example of the system, optionally including one or more or each of the first through ninth examples, the one or more fluid channels merge only at the inlet and at the outlet.

The disclosure also provides support for a battery assembly, comprising: a plurality of battery cells, and a cold plate in contact with the plurality of battery cells, the cold plate configured to extract heat from the plurality of battery cells by flowing a fluid through a set of channels arranged in the cold plate, the set of channels forming a serpentine path through the cold plate and wherein the set of channels are configured with one or more of portions of reduced diameter to increase a flow rate of a fluid therethrough, a section of one channel of the set of channels shifted away from an adjacent battery cell of the plurality of battery cells, and a plurality of mixing channels disposed along a final portion of the set of channels. In a first example of the system, the fluid is a mixture of refrigerant and oil circulated through a heating, ventilation, and air conditioning system of a vehicle.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A cold plate for a battery, comprising:
a plurality of channels spaced apart from one another and arranged in parallel flow, each channel of the plurality of channels including a portion with one or more of a narrowed cross-sectional area, width, or diameter extending between a common outlet of the plurality of channels and an intermediate-point of each channel.

2. The cold plate of claim 1, wherein a segment of an outer channel of the plurality of channels is shifted away from a battery cell to reduce heat transfer between the outer channel and the battery cell.

3. The cold plate of claim 1, wherein the intermediate-point of each channel of the plurality of channels corresponds to a point along a total length of each channel where a vapor quality of a fluid flowing through the plurality of channels reaches a threshold and wherein a location of the intermediate-point along the total length differs amongst the plurality of channels.

4. The cold plate of claim 1, wherein the plurality of channels forms a serpentine path through the cold plate and wherein the plurality of channels extends along an outer region of the cold plate from a common inlet and bends to wind back along an inner region of the cold plate to merge at the common outlet.

5. The cold plate of claim 4, wherein the common inlet is arranged adjacent to the common outlet and wherein the common inlet and the common outlet are aligned along a width of the cold plate.

6. The cold plate of claim 2, wherein the portion of the outer channel shifted away from the battery cell extends along a same side of the cold plate as a common inlet and the common outlet.

7. The cold plate of claim 1, further comprising a plurality of mixing conduits fluidly coupling the plurality of channels to one another, the plurality of mixing conduits arranged within the portion with the one or more of the narrowed cross-sectional area, width, or diameter of each channel.

8. A battery cold plate, comprising:
an inlet arranged adjacent to an outlet of the battery cold plate, the inlet and the outlet configured to flow a fluid into and out of the battery cold plate, respectively;
one or more fluid channels extending between the inlet and the outlet, the one or more fluid channels each having first portion with a first diameter and a second portion with a second, reduced diameter; and
wherein the second portion begins at a point along a length of each of the one or more fluid channels where a vapor quality of the fluid reaches a threshold and ends at the outlet.

9. The battery cold plate of claim 8, wherein the inlet is arranged adjacent to the outlet without any components positioned between the inlet and the outlet.

10. The battery cold plate of claim 8, wherein the one or more fluid channels includes a first, outer channel, a second, middle channel, and a third, inner channel and wherein the first, second, and third channels are arranged parallel with one another and spaced apart from one another between the inlet and the outlet.

11. The battery cold plate of claim 10, wherein each of the one or more fluid channels has a plurality of segments continuously coupled by 90-degree bends, and wherein at a fourth segment of the plurality of segments, the outer channel is shifted closer to an edge of the plate relative to an alignment of inlet and outlet ends of the one or more fluid channels along a width of the battery cold plate.

12. The battery cold plate of claim 10, further comprising a first row of mixing conduits extending between and fluidly coupling the first channel to the second channel and a second row of mixing conduits extending between and fluidly coupling the second channel to the third channel and wherein the first and second rows of mixing conduits are located along the second portion of the first, second and third channels.

13. The battery cold plate of claim 8, wherein the point where the vapor quality of the fluid reaches the threshold is positioned at a different location along a length of each of the one or more fluid channels.

14. The battery cold plate of claim 8, wherein the fluid is a mixture of a refrigerant and an oil and wherein the refrigerant has a lower boiling point than the oil.

15. The battery cold plate of claim 14, wherein the point where the vapor quality of the fluid reaches the threshold is a point where the vapor quality of the refrigerant reaches the threshold and the oil is at least partially suspended as a liquid mist in the refrigerant.

16. The battery cold plate of claim 8, wherein a pressure in the first portion is higher than a pressure in the second portion of the one or more fluid channels and a flow velocity is higher in the second portion than the first portion.

17. The battery cold plate of claim 8, wherein the threshold is a vapor quality configured to increase a pressure gradient in the second portion relative to the first portion of the one or more fluid channels.

18. The battery cold plate of claim 8, wherein the one or more fluid channels merge only at the inlet and at the outlet.

19. A battery assembly, comprising:
a plurality of battery cells; and
a cold plate in contact with the plurality of battery cells, the cold plate configured to extract heat from the plurality of battery cells by flowing a fluid through a set of channels arranged in the cold plate, the set of channels forming a serpentine path through the cold plate and wherein the set of channels are configured with one or more of portions of reduced diameter to increase a flow rate of a fluid therethrough, a section of one channel of the set of channels shifted away from an adjacent battery cell of the plurality of battery cells, and a plurality of mixing channels disposed along a final portion of the set of channels.

20. The battery assembly of claim 19, wherein the fluid is a mixture of refrigerant and oil circulated through a heating, ventilation, and air conditioning system of a vehicle.
